(19) United States
(12) Patent Application Publication
(10) Pub. No.: US 2025/0031073 A1
(43) Pub. Date: Jan. 23, 2025

(54) COMMUNICATION METHOD AND APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 18/712,141

(22) PCT Filed: Nov. 22, 2021
(86) PCT No.: PCT/CN2021/132152

§ 371 Date: May 21, 2024

(51) Int. Cl. H04W 24/08; H04W 12/06; H04W 24/10; H04W 84/12

(52) U.S. Cl. CPC H04W 24/08; H04W 12/06; H04W 24/10; H04W 84/12

(57) ABSTRACT

The communication method is performed by an initiator. The method includes: determining a target wireless frame, wherein the target wireless frame comprises a first identification bit, and the first identification bit indicates that the type of the target wireless frame is a wireless local area network sensing Null Data Packet Announcement (WLAN Sensing NDPA) frame; and sending the target wireless frame.

### CROSS-REFERENCE TO RELATED APPLICATIONS

The present application is a U.S. National Stage of International Application No. PCT/CN2021/132152, filed on Nov. 22, 2021, the contents of all of which are incorporated herein by reference in their entireties for all purposes.

### BACKGROUND

With rapid development of the mobile communication technology, the Wireless Fidelity (Wi-Fi) technology has made great progress in transmission rate, throughput, and the like. Currently, the research on the Wi-Fi technology includes bandwidth transmission of 320 MHZ, aggregation and coordination of a plurality of frequency bands, etc., and its application scenarios include video transmission, Augmented Reality (AR), Virtual Reality (VR), etc.

### SUMMARY

Examples of the disclosure relate to the technical field of mobile communications, and in particular, the examples of the disclosure relate to a communication method and apparatus, an electronic device, and a storage medium.

In a first aspect, a communication method performed by an initiator is provided by an example of the disclosure, and includes: determining a target wireless frame, where the target wireless frame includes a first identification bit indicating that a type of the target wireless frame is a wireless local area network sensing Null Data Packet Announcement (WLAN Sensing NDPA) frame; and sending the target wireless frame.

In a second aspect, a communication method performed by a responder is further provided by an example of the disclosure, and includes: receiving a target wireless frame, and acquiring a first identification bit carried in the target wireless frame, the first identification bit indicating that a type of the target wireless frame is a wireless local area network sensing Null Data Packet Announcement (WLAN Sensing NDPA) frame; and performing a processing operation based on the first identification bit.

In a third aspect, An electronic device is further provided by an example of the disclosure, including a memory, one or more processors and a computer program stored on the memory and executable on the one or more processors, where the one or more processors are collectively configured to execute the computer program to implement one or more of the methods according to the examples of the disclosure.

In a fourth aspect, a non-transitory computer-readable storage medium is further provided by an example of the disclosure, storing a computer program which, when executed by one or more processors, implements one or more of the methods according to the examples of the disclosure.

Additional aspects and advantages of the examples of the disclosure will be given in part in the following description, and will be obvious from the following description, or will be understood by practice of the disclosure.

### BRIEF DESCRIPTION OF DRAWINGS

In order to illustrate the technical solutions of the examples of the disclosure more clearly, the accompanying drawings required to be used in the description of the examples of the disclosure will be briefly introduced below. Obviously, the accompanying drawings in the following description are some examples of the disclosure, and for those of ordinary skill in the art, other drawings can be obtained according to these drawings without paying inventive steps.

FIG. 1 is a flowchart of a communication method according to an example of the disclosure.

FIG. 2 is a first schematic diagram of a first example of the example of the disclosure.

FIG. 3 is a second schematic diagram of the first example of the example of the disclosure.

FIG. 4 is a third schematic diagram of the first example of the example of the disclosure.

FIG. 5 is a first schematic diagram of a second example of the example of the disclosure.

FIG. 6 is a second schematic diagram of the second example of the example of the disclosure.

FIG. 7 is a flowchart of a communication method according to an example of the disclosure.

FIG. 8 is a schematic structural diagram of a communication apparatus according to an example of the disclosure.

FIG. 9 is a schematic structural diagram of a communication apparatus according to an example of the disclosure.

FIG. 10 is a schematic structural diagram of an electronic device according to an example of the disclosure.

### DETAILED DESCRIPTION

In the examples of the disclosure, the term “and/or” describes an association relationship of associated objects, and indicates that three relationships may exist, for example, A and/or B may indicate that A exists alone, A and B simultaneously exist, and B exists alone. The character “/” generally indicates that front and back associated objects have an “or” relationship.

In the examples of the disclosure, the term “a plurality of” refers to two or more, and other quantifiers are similar to this.

Examples will be described in detail here, instances of which are shown in accompanying drawings. When the following description relates to the drawings, the same numbers in different drawings represent the same or similar elements unless otherwise indicated. The examples described in the following examples do not represent all examples consistent with the disclosure. Rather, they are merely examples of apparatuses and methods consistent with some aspects of the disclosure as detailed in the appended claims.

The terms used in the disclosure are intended to describe particular examples and are not intended to limit the disclosure. As used in the disclosure and the appended claims, the singular forms “a/an”, “said”, and “the” are intended to include the plural forms as well, unless the context clearly indicates otherwise. It should also be understood that the term “and/or” used here refers to and includes any and all possible combinations of one or more of the associated listed items.

It should be understood that although the terms such as first, second and third may be employed in the disclosure to describe various information, these pieces of information should not be limited to these terms. These terms are used to distinguish the same type of information from one another. For example, first information may also be referred to as second information, and similarly, second information may also be referred to as first information, without departing from the scope of the disclosure. The word “if” used here may be interpreted as “at the time of” or “when” or “in response to determining,” for example, depending on the context.

The technical solutions in the examples of the disclosure will be clearly and completely described below with reference to the accompanying drawings in the examples of the disclosure. The described examples are a part of the examples of the disclosure, and not all of the examples. Based on the examples in the disclosure, all other examples obtained by those of ordinary skill in the art without making inventive steps belong to the scope of protection of the disclosure.

Among the Wi-Fi technologies currently researched, the Wireless Local Area Network (WLAN) Sensing technology may be supported. For example, application scenarios such as location discovery, Proximity Detection, and Presence Detection in dense environments (such as home environments and enterprise environments). In the process of WLAN Sensing, Null Data Packet Announcement (NDPA) is used to measure sensing, and thus, a format of a NDPA frame needs to be provided.

Examples of the disclosure provide a communication method and apparatus, an electronic device, and a storage medium, to provide a format of a Null Data Packet Announcement (NDPA) frame.

The method and the apparatus are based on the same application concept, since the principle of solving the problem of the method and the apparatus is similar, the implementation of the apparatus and the method can be referred to each other, and the description will not be repeated.

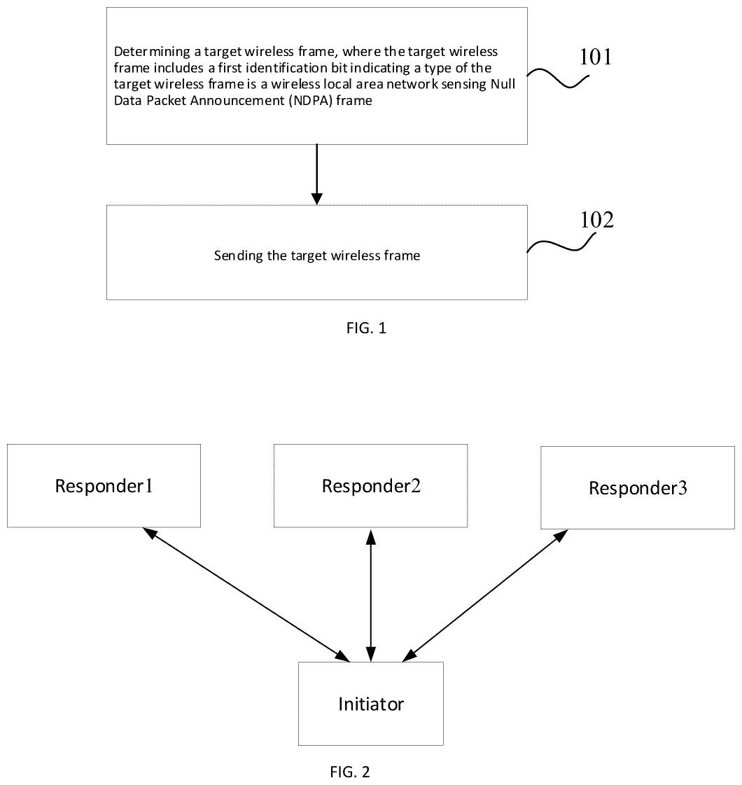

As shown in FIG. 1, an example of the disclosure provides a communication method, in some examples, the method can be performed by a network device that is an initiator (a Sensing Initiator), and the initiator may be a Sensing Transmitter of a wireless local area network sensing measurement process or a device that does not participate in a wireless local area network sensing measurement process.

The method may include steps 101 ad 102.

Step 101, a target wireless frame is determined; where the target wireless frame includes a first identification bit indicating that a type of the target wireless frame is a wireless local area network sensing Null Data Packet Announcement (NDPA) frame.

As a first example, referring to FIGS. 2 to 4, an architecture of WLAN Sensing applied by the communication method provided by the example of the disclosure and a WLAN Sensing process are first introduced.

FIG. 2 shows an architecture schematic diagram of WLAN Sensing. Where a Sensing Initiator initiates WLAN Sensing (e.g., initiates a WLAN sensing session), and there may be a plurality of Sensing Responders (or Sensing Receivers) responding to the WLAN Sensing, for example, a responder 1, a responder 2, and a responder 3 shown in FIG. 2. When the sensing initiator initiates the WLAN Sensing, a plurality of associated or unassociated sensing responders of the WLAN Sensing may respond; and as shown in FIG. 2, the responder 1, the responder 2, and the responder 3 may be respectively associated or unassociated with the initiator. Where “associated” may refer to an associated connection for communication being established between a sensing initiator and a sensing responder, and “unassociated” may refer to an associated connection for communication not being established between a sensing initiator and a sensing responder.

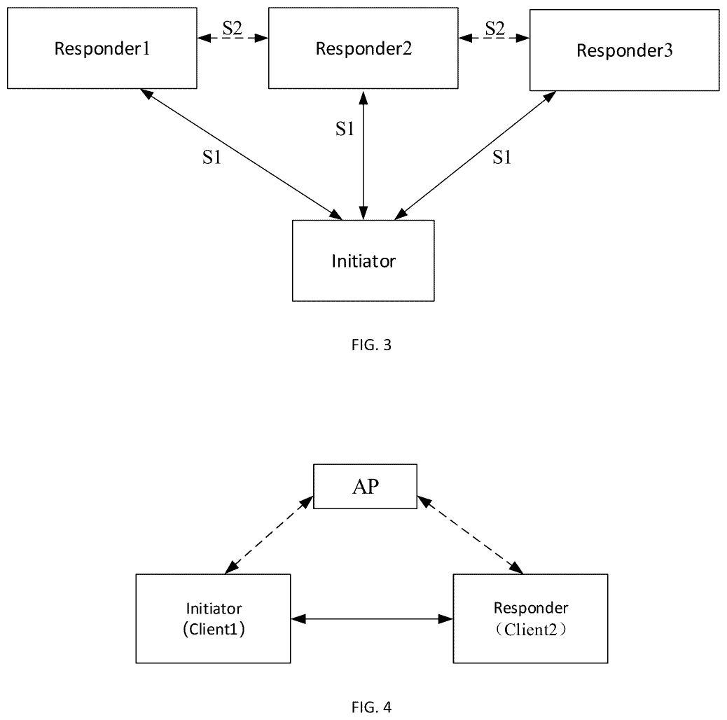

Referring to FIG. 3, the sensing initiator and the sensing responders communicate through communication connections, as shown by communication connections S1; the sensing responders communicate with each other through communication connections S2.

Where each sensing initiator may be a client; and each sensing responder (i.e., a sensing responder 1 to a sensing responder 3 in this example) may be a station (STA) device. The STA may assume a plurality of roles in a WLAN sensing process, for example, in the WLAN sensing process, the sensing initiator may be a Sensing Transmitter, a Sensing Receiver, or both, or neither. In the WLAN sensing process, the sensing responder may also be a sensing transmitter, a sensing receiver, or both.

As another architecture, as shown in FIG. 4, the sensing initiator and the sensing responder may also each be a client, and both the sensing initiator and the sensing responder may communicate by connecting to the same AP; and in FIG. 4, a Client1 is the sensing initiator and a Client2 is the sensing responder.

In the WLAN sensing process, an initiator determines a target wireless frame in which a first identification bit is carried, and the first identification bit is configured to indicate that a type of the target wireless frame is a WLAN Sensing NDPA frame. In a WLAN Sensing scenario, the NDPA (Null Data Packet Announcement) frame is configured to instruct the responder to send a Null Data Packet (NDP).

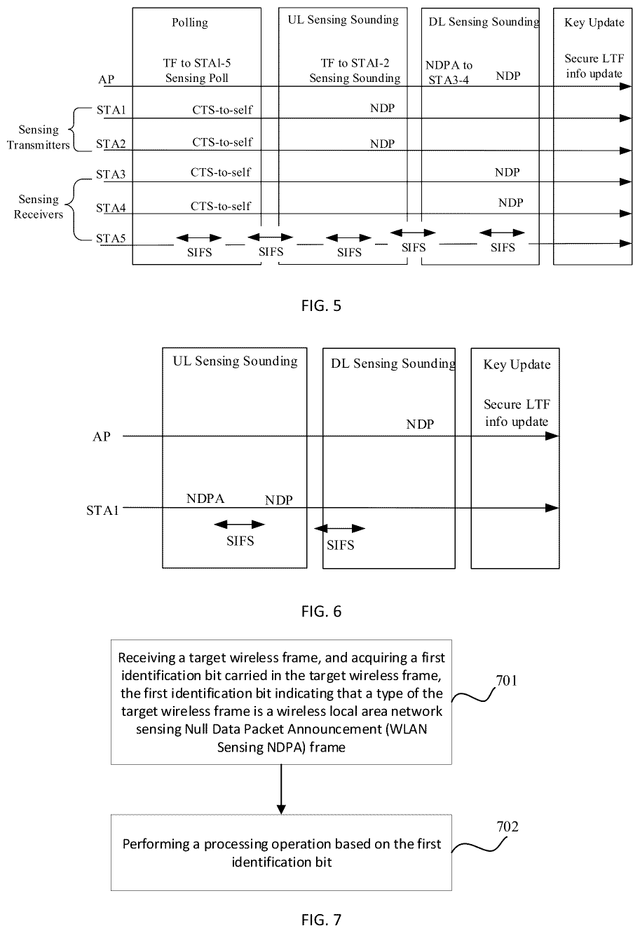

As a second example, referring to FIG. 5, FIG. 5 shows a WLAN Sensing scenario, which may include the following procedures: Polling, UL Sensing Sounding, DL Sensing Sounding, and Key Update, where key update refers to update of a random key of an LTF (long training field), and the LTF is a component of an NDP frame.

In the Polling procedure, a sensing initiator AP performs a polling procedure on sensing receivers STA1 to STA5; and STA1 to STA2, which are used as Sensing Transmitters in FIG. 5, and STA3 to STA4, which are used as Sensing Receivers in FIG. 5, each enable a CTS-to-self protection mechanism while also identifying the presence of a station.

In the UL Sensing Sounding, the sensing initiator AP performs sensing sounding on STA1 and STA2; and STA1 to STA2 respectively send a Null Data Packet (NDP) frame, where the NDP includes a Short Training Field (STF) and a Long Training Field (LTF).

In the DL Sensing Sounding procedure, the sensing initiator AP sends a target wireless frame to STA3 and STA4, which are used as sensing responders, a first identification bit is carried in the target wireless frame, the first identification bit indicating that the wireless frame is an NDPA frame (i.e., in FIG. 5: NDPA to STA3-4), and an NDP frame is sent; and STA3 and STA4 respectively send the NDP frame to the AP after receiving the target wireless frame.

In the Key Update procedure, the sensing initiator AP performs LTF information update.

In the above procedures, an NSP frame is sent by STA5 as sensing responders, a Short Inter Frame Space (SIFS) is configured to space frames requiring immediate response, and the shortest interval is used between two transmissions of a frame exchange sequence, so that other stations waiting for a medium can be prevented from attempting to use the medium.

Referring to FIG. 6, as another WLAN Sensing scenario, the following procedures may be included: UL Sensing Sounding, DL Sensing Sounding, and Key Update.

In the UL Sensing Sounding, STA1 sends a target wireless frame in which a first identification bit is carried, the first identification bit indicating that the wireless frame is an NDPA frame, and an NDP frame is sent.

In the DL Sensing Sounding procedure, a sensing initiator AP sends an NDP frame to STA1, which is used as a sensing responder.

In the Key Update procedure, the AP performs LTF information update.

Returning to FIG. 1, in step 102, the target wireless frame is sent.

An initiator sends the target wireless frame to a responder to indicate the responder that a type of the wireless frame is an NDPA frame, so that the responder sends a NDP frame to the initiator according to the NDPA frame.

As an example, the target wireless frame may identify the first identification bit in a form in Table 1 below:

TABLE 1

| NDP Announcement Type subfield | | NDP Announcement |
|---|---|---|
| B 1 | B 0 | frame variant |
| 0 | 0 | VHT NDP Announcement frame |
| 0 | 1 | Ranging NDP Announcement frame |
| 1 | 0 | HE NDP Announcement frame |
| 1 | 1 | WLAN sensing NDPA frame |

As shown in Table 1, a NDP Announcement Type subfield may be set in the target wireless frame, this field occupies 2 bits (B0 and B1 shown in Table 1), and different values of B0 and B1 represent different NDP Announcement frame variants; for example, “00” indicates that a frame type is a VHT (Very High Throughput) NDP Announcement frame, “01” indicates that the frame type is a ranging NDP Announcement frame, “10” indicates that the frame type is an HE (High-Efficiency) NDP Announcement frame, and “11” indicates that the frame type is a wireless local area network (WLAN) sensing NDPA frame.

In the example of the disclosure, the initiator determines the target wireless frame and sends the target wireless frame, and the target wireless frame includes the first identification bit indicating that the type of the target wireless frame is the WLAN sensing Null Data Packet Announcement (NDPA) frame; and the format of the NDPA frame is provided by the examples of the disclosure to achieve WLAN sensing measurement.

In one example, the target wireless frame includes a Null Data Packet Announcement (NDPA) type field in which the first identification bit is carried; and for example, the format of the target wireless frame is shown in Table 2 below:

TABLE 2

| Bit sequence: | B 0-B 1 | B 2-B 7 |
|---|---|---|
| | NDP Announcement | Sounding Dialog |
| | Type | Token Number |
| bits: | 2 | 6 |

Where the target wireless frame includes an NDP Announcement type field and a sounding dialog token number field; the NDP Announcement type field includes 2 bits, which are B0 and B1, respectively; and the sounding dialog token number field includes 6 bits, i.e., B2 and B7.

In one example, the target wireless frame includes a sounding dialog token number field; and

a session identification of a sensing measurement session and an event identification of a measurement event included in the sensing measurement session are included in the sounding dialog token number field; as shown in an example in Table 2 above, the Sounding Dialog Token Number field includes 6 bits, where each value is a sensing measurement session ID modulo 64 (a mod operation); in addition, since each measurement session may contain a plurality of measurement events, it may be necessary to add new bits to identify each measurement event ID, for example, 6 new bits are added.

Or 3 bits of the 6 bits shown in Table 2 are used to identify the measurement session ID and the remaining 3 bits are used to identify the measurement event ID.

In some examples, the Sounding Dialog Token Number value may be obtained from a Sensing Session Setup process.

In an example, the target wireless frame includes one station information (STA info) field; and the STA info field includes an association identifier (AID) identification bit or a user identifier (UID) identification bit, the AID identification bit or the UID identification bit indicating a responder of sensing sounding; and AID denotes Association Identifier, and UID denotes User Identifier.

Taking Non-Triggered Based Sounding (Non-TB) as an example, for example, during DL sounding, the NDPA frame may include one STA info subfield containing AID bits or UID bits, which may be 2047, for identifying the AP as a responder of sensing measurement.

In an example, the STA info field further includes a Sequence Authentication Code (SAC) identification bit indicating that the target wireless frame uses an encrypted Long Training Field (LTF).

In an example, a Receiver Address (RA) of the target wireless frame includes a Medium Access Control (MAC) address of the initiator, i.e., the RA of the NDPA frame is the MAC address of the initiator.

In an example, the target wireless frame includes at least one STA info field; and the STA info field includes an association identifier (AID) identification bit assigned by the initiator to a responder during association. Taking TB sounding as an example, for example, during UL sounding, the NDPA frame may possibly include one or at least two STA info subfields containing AID bits assigned by the initiator (e.g., AP) to the responder (e.g., STA) during association.

In an example, the target wireless frame further includes at least one of an R21 NSS field, an NSS repetition field, and an I2R NSS field. Where R21 refers to send form RSTA (Responding STA) to ISTA (Initiating STA) and I2R refers to send form the ISTA to the RSTA; and NSS indicates the Number of Spatial Streams, and NSS repetition indicates the number of NSS repetitions.

In one example, a Receiver Address (RA) of the target wireless frame includes a broadcast address or a unicast address; and the broadcast address is an address broadcast to all responders (e.g., STAs), and the unicast address includes a Media Access Control (MAC) address of each of the responders.

In one example, after sending the target wireless frame, the method further includes: receiving a null data packet (NDP) sent by a responder; or sending a trigger frame to the responder, and receiving a null data packet (NDP) sent by the responder.

For a Non-TB sounding scenario, the responder may directly send the DNP to the initiator after receiving the NDPA frame; and for a TB sounding scenario, the initiator sends a trigger frame to the responder after sending the DNPA frame, and then the responder sends the NDP to the initiator based on the trigger frame.

In the example of the disclosure, the initiator determines the target wireless frame and sends the target wireless frame, and the target wireless frame includes the first identification bit indicating that the type of the target wireless frame is the WLAN sensing Null Data Packet Announcement (NDPA) frame; and the format of the NDPA frame is provided by the examples of the disclosure, so that a WLAN sensing mechanism is enabled to be applied, the sensing initiator and the responder can achieve WLAN sensing, and measurement event results are fed back timely, reducing interference to other devices.

As shown in FIG. 7, an example of the disclosure further provides a communication method, in some examples, the method may be performed by a responder (i.e., a sensing responder), the responder may be a sensing receiver of a wireless local area network sensing measurement process, and the method includes the following steps:

Step 701, a target wireless frame is received, and a first identification bit carried in the target wireless frame is acquired, the first identification bit indicating that a type of the target wireless frame is a wireless local area network sensing Null Data Packet Announcement (WLAN Sensing NDPA) frame.

As a first example, referring to FIGS. 2 to 4, an architecture of WLAN Sensing applied by the communication method provided by the example of the disclosure, and a WLAN Sensing process are first introduced, and specific contents refer to the above example, which are not repeated here.

As a second example, referring to FIGS. 5 to 6, two WLAN Sensing scenarios are shown.

The WLAN Sensing scenario shown in FIG. 5 may include the following procedures: Polling, UL Sensing Sounding, DL Sensing Sounding, and Key Update.

In the Polling procedure, a sensing initiator AP performs a polling procedure on sensing receivers STA1 to STA5; and STA1 to STA2, which are used as Sensing Transmitters in FIG. 5, and STA3 to STA4, which are used as Sensing Receivers in FIG. 5, each enable a CTS-to-self protection mechanism while also identifying the presence of a station.

In the UL Sensing Sounding, the sensing initiator AP performs sensing sounding on STA1 and STA2; and STA1 to STA2 respectively send a Null Data Packet (NDP) frame, where the NDP includes a Short Training Field (STF) and a Long Training Field (LTF).

In the DL Sensing Sounding procedure, the sensing initiator AP sends a target wireless frame to STA3 and STA4, which are used as sensing responders, a first identification bit is carried in the target wireless frame, the first identification bit indicating that the wireless frame is an NDPA frame (i.e., in FIG. 5: NDPA to STA3-4), and an NDP frame is sent; and the sensing responders STA3 and STA4 respectively feed back the NDP frame to the AP after receiving the target wireless frame.

In the Key Update procedure, the sensing initiator AP performs LTF information update.

In the above procedures, an NSP frame is sent by STA5 as sensing responders, a Short Inter Frame Space (SIFS) is configured to space frames requiring immediate response, and the shortest interval is used between two transmissions of a frame exchange sequence, so that other stations waiting for a medium can be prevented from attempting to use the medium.

Referring to FIG. 6, as another WLAN Sensing scenario, the following procedures may be included: UL Sensing Sounding, DL Sensing Sounding, and Key Update.

In the UL Sensing Sounding, STA1 sends a target wireless frame (i.e., an NDPA frame) in which a first identification bit is carried, the first identification bit indicating that the wireless frame is the NDPA frame, and an NDP frame is sent.

In the DL Sensing Sounding procedure, a sensing initiator AP sends an NDP frame to STA1, which is used as a sensing responder.

In the Key Update procedure, the AP performs LTF information update.

Step 702, a processing operation is performed based on the first identification bit.

The responder confirms that the type of the wireless frame is the NDPA frame based on the first identification bit, and then the processing operation is performed, the processing operation including sending the NDP frame to the initiator.

In an example, performing the processing operation based on the first identification bit includes: receiving a trigger frame sent by the initiator, and sending a null data packet (NDP) to the initiator; or sending a null data packet (NDP) to the initiator.

For a Non-TB sounding scenario, the responder may directly send the DNP to the initiator after receiving the NDPA frame; and for a TB sounding scenario, the initiator sends a trigger frame to the responder after sending the DNPA frame, and then the responder sends the NDP to the initiator based on the trigger frame.

In the example of the disclosure, the responder receives the target wireless frame, and acquires the first identification bit carried in the target wireless frame, and the processing operation is performed based on the first identification bit; where the first identification bit indicates that the type of the target wireless frame is the wireless local area sensing Null Data Packet Announcement (WLAN sensing NDPA) frame; and the format of the NDPA frame is provided by the examples of the disclosure, so that a WLAN sensing mechanism is enabled to be applied, the sensing initiator and the responder can achieve WLAN sensing, and measurement event results are fed back timely, reducing interference to other devices.

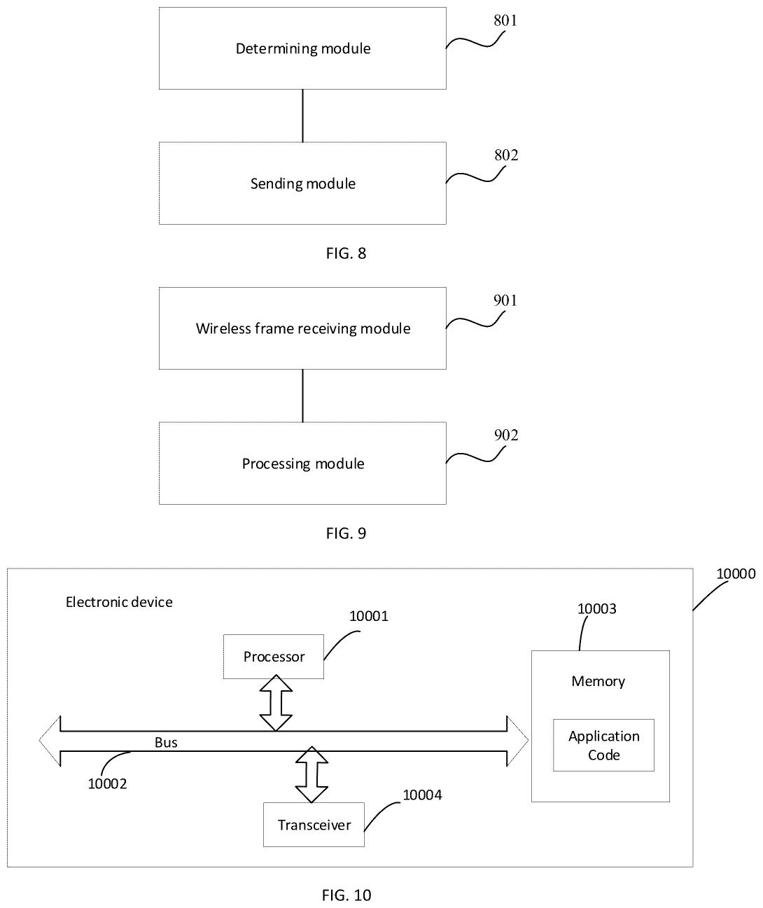

Based on the same principle as that in the method provided by the example of the disclosure, an example of the disclosure further provides a communication apparatus performed by an initiator, as shown in FIG. 8, including 801 and 802.

a determining module 801, configured to determine a target wireless frame; where the target wireless frame includes a first identification bit indicating that a type of the target wireless frame is a wireless local area network sensing Null Data Packet Announcement (NDPA) frame.

As a first example, referring to FIGS. 2 to 4, an architecture of WLAN Sensing applied by the communication method provided by the example of the disclosure, and a WLAN Sensing process are first introduced, and specific contents refer to the above example, which are not repeated here.

In the WLAN sensing process, an initiator determines a target wireless frame in which a first identification bit is carried, and the first identification bit is configured to indicate that a type of the target wireless frame is a WLAN Sensing NDPA frame. In a WLAN Sensing scenario, the NDPA frame is configured to instruct the responder to send a Null Data Packet (NDP).

As a second example, referring to FIGS. 5 to 6, two WLAN Sensing scenarios are shown.

The WLAN Sensing scenario shown in FIG. 5 may include the following procedures: Polling, UL Sensing Sounding, DL Sensing Sounding, and Key Update.

In the Polling procedure, a sensing initiator AP performs a polling procedure on sensing receivers STA1 to STA5; and STA1 to STA2, which are used as Sensing Transmitters in FIG. 5, and STA3 to STA4, which are used as Sensing Receivers in FIG. 5, each enable a CTS-to-self protection mechanism while also identifying the presence of a station.

In the UL Sensing Sounding, the sensing initiator AP performs sensing sounding on STA1 and STA2; and STA1 to STA2 respectively send a Null Data Packet (NDP) frame, where the NDP includes a Short Training Field (STF) and a Long Training Field (LTF).

In the DL Sensing Sounding procedure, the sensing initiator AP sends a target wireless frame to STA3 and STA4, which are used as sensing responders, a first identification bit is carried in the target wireless frame, the first identification bit indicating that the wireless frame is an NDPA frame (i.e., in FIG. 5: NDPA to STA3-4), and an NDP frame is sent; and the sensing responders STA3 and STA4 respectively feed back the NDP frame to the AP after receiving the target wireless frame.

In the Key Update procedure, the sensing initiator AP performs LTF information update.

In the above procedures, an NSP frame is sent by STA5 as sensing responders, a Short Inter Frame Space (SIFS) is configured to space frames requiring immediate response, and the shortest interval is used between two transmissions of a frame exchange sequence, so that other stations waiting for a medium can be prevented from attempting to use the medium.

Referring to FIG. 6, as another WLAN Sensing scenario, the following procedures may be included: UL Sensing Sounding, DL Sensing Sounding, and Key Update.

In the UL Sensing Sounding, STA1 sends a target wireless frame (i.e., an NDPA frame), a first identification bit carried in the target wireless frame, the first identification bit indicating that the wireless frame is the NDPA frame, and an NDP frame is sent.

In the DL Sensing Sounding procedure, a sensing initiator AP sends an NDP frame to STA1, which is used as a sensing responder.

In the Key Update procedure, the AP performs LTF information update.

A sending module 802, configured to send the target wireless frame.

An initiator sends the target wireless frame to a responder to indicate the responder that a type of the wireless frame is an NDPA frame, so that the responder sends a NDP frame to the initiator according to the NDPA frame.

As an example, the target wireless frame may identify the first identification bit in a form in Table 1 (reproduced here for convenience) below:

TABLE 1

| NDP Announcement Type subfield | | NDP Announcement |
|---|---|---|
| B 1 | B 0 | frame variant |
| 0 | 0 | VHT NDP Announcement frame |
| 0 | 1 | Ranging NDP Announcement frame |
| 1 | 0 | HE NDP Announcement frame |
| 1 | 1 | WLAN sensing NDPA frame |

As shown in Table 1, a NDP Announcement Type subfield may be set in the target wireless frame, this field occupies 2 bits (B0 and B1 shown in Table 1), and different values of B0 and B1 represent different NDP Announcement frame variants; for example, “00” indicates that a frame type is a VHT (Very High Throughput) NDP Announcement frame, “01” indicates that the frame type is a ranging NDP Announcement frame, “10” indicates that the frame type is an HE (High-Efficiency) NDP Announcement frame, and “11” indicates that the frame type is a wireless local area network (WLAN) sensing NDPA frame.

In some examples, in the example of the disclosure, the target wireless frame includes a Null Data Packet Announcement (NDPA) type field in which the first identification bit is carried.

In some examples, in the example of the disclosure, the target wireless frame includes a sounding dialog token number field; and the sounding dialog token number field includes a session identification of a sensing measurement session and an event identification of a measurement event included in the sensing measurement session.

In some examples, in the example of the disclosure, the target wireless frame includes one station information (STA info) field; and the STA info field includes an association identifier (AID) identification bit or a user identifier (UID) identification bit, the AID identification bit or the UID identification bit indicating a responder of the sensing sounding.

In some examples, in the example of the disclosure, the STA info field further includes a sequence authentication code (SAC) identification bit indicating that the target wireless frame uses an encrypted long training field (LTF).

In some examples, in the example of the disclosure, a receiver address (RA) of the target wireless frame includes a medium access control (MAC) address of the initiator.

In some examples, in the example of the disclosure, the target wireless frame includes at least one STA info field; and the STA info field includes an association identifier (AID) identification bit assigned by the initiator to a responder during association.

In some examples, in the example of the disclosure, the target wireless frame further includes at least one of an R21 NSS field, an NSS repetition field, and an I2R NSS field.

In some examples, in the example of the disclosure, a Receiver Address (RA) of the target wireless frame includes a broadcast address or a unicast address; and the unicast address includes a media access control (MAC) address of a responder.

In some examples, in the example of the disclosure, the apparatus further includes: a first receiving module, configured to receive a Null Data Packet (NDP) sent by a responder; or a second receiving module, configured to send a trigger frame to the responder, and receive an NDP sent by the responder.

In the example of the disclosure, the determining module 801 determines the target wireless frame, the sending module 802 sends the target wireless frame, the target wireless frame includes the first identification bit indicating that the type of the target wireless frame is the WLAN sensing Null Data Packet Announcement (NDPA) frame; and the format of the NDPA frame is provided by the examples of the disclosure to achieve WLAN sensing measurement.

An example of the disclosure further provides a communication apparatus, performed by a responder, as shown in FIG. 9, including:

a wireless frame receiving module 901, configured to receive a target wireless frame, and acquire a first identification bit carried in the target wireless frame, the first identification bit indicating that a type of the target wireless frame is a wireless local area network sensing Null Data Packet Announcement (WLAN Sensing NDPA) frame;

As a first example, referring to FIGS. 2 to 4, an architecture of WLAN Sensing applied by the communication method provided by the example of the disclosure, and a WLAN Sensing process are first introduced, and specific contents refer to the above example, which are not repeated here.

As a second example, referring to FIGS. 5 to 6, two WLAN Sensing scenarios are shown.

The WLAN Sensing scenario shown in FIG. 5 may include the following procedures: Polling, UL Sensing Sounding, DL Sensing Sounding, and Key Update.

In the Polling procedure, a sensing initiator AP performs a polling procedure on sensing receivers STA1 to STA5; and STA1 to STA2, which are used as Sensing Transmitters in FIG. 5, and STA3 to STA4, which are used as Sensing Receivers in FIG. 5, each enable a CTS-to-self protection mechanism while also identifying the presence of a station.

In the UL Sensing Sounding, the sensing initiator AP performs sensing sounding on STA1 and STA2; and STA1 to STA2 respectively send a Null Data Packet (NDP) frame, where the NDP includes a Short Training Field (STF) and a Long Training Field (LTF).

In the DL Sensing Sounding procedure, the sensing initiator AP sends a target wireless frame to STA3 and STA4, which are used as sensing responders, a first identification bit is carried in the target wireless frame, the first identification bit indicating that the wireless frame is an NDPA frame (i.e., in FIG. 5: NDPA to STA3-4), and an NDP frame is sent; and the sensing responders STA3 and STA4 respectively feed back the NDP frame to the AP after receiving the target wireless frame.

In the Key Update procedure, the sensing initiator AP performs LTF information update.

In the above procedures, an NSP frame is sent by STA5 as sensing responders, a Short Inter Frame Space (SIFS) is configured to space frames requiring immediate response, and the shortest interval is used between two transmissions of a frame exchange sequence, so that other stations waiting for a medium can be prevented from attempting to use the medium.

Referring to FIG. 6, as another WLAN Sensing scenario, the following procedures may be included: UL Sensing Sounding, DL Sensing Sounding, and Key Update.

In the UL Sensing Sounding, STA1 sends a target wireless frame (i.e., an NDPA frame), a first identification bit carried in the target wireless frame, the first identification bit indicating that the wireless frame is the NDPA frame, and an NDP frame is sent.

In the DL Sensing Sounding procedure, a sensing initiator AP sends an NDP frame to STA1, which is used as a sensing responder.

In the Key Update procedure, the AP performs LTF information update.

A processing module 902, configured to perform a processing operation based on the first identification bit.

The processing module 902 confirms that the type of the wireless frame is the NDPA frame based on the first identification bit, and then the processing operation is performed, the processing operation including sending the NDP frame to the initiator.

In an example, the processing module 902 includes: a first sending submodule, configured to receive a trigger frame sent by the initiator, and send a Null Data Packet (NDP) to the initiator; or a second sending submodule, configured to send a null data packet (NDP) to the initiator.

In the example of the disclosure, the wireless frame receiving module 901 receives the target wireless frame, and acquires the first identification bit carried in the target wireless frame, and the processing module 902 performs the processing operation based on the first identification bit; where the first identification bit indicates that the type of the target wireless frame is the wireless local area sensing Null Data Packet Announcement (WLAN sensing NDPA) frame; and the format of the NDPA frame is provided by the examples of the disclosure, so that a WLAN sensing mechanism is enabled to be applied, the sensing initiator and the responder can achieve WLAN sensing, and measurement event results are fed back timely, reducing interference to other devices.

In an example, an example of the disclosure further provides an electronic device, and as shown in FIG. 10, the electronic device 10000 shown in FIG. 10 may be a server, including: processor 10001 and a memory 10003. The processor 10001 and the memory 10003 are connected, e.g., via a bus 10002. In some examples, the electronic device 10000 may also include a transceiver 10004. It should be noted that the transceiver 10004 is not limited to one in practical application, and a structure of the electronic device 10000 does not constitute a limitation of the examples of the disclosure.

The processor 10001 may be a Central Processing Unit (CPU), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination of them. The processor 10001 may implement or perform various illustrative logical blocks, modules, and circuits described in connection with the contents of the disclosure. The processor 10001 may also be a combination that implements computing functions, including, for example, a combination of one or more microprocessors, a combination of a DSP and a microprocessor, and the like.

The bus 10002 may include a path for transmitting information between the above components. The bus 10002 may be a PCI (Peripheral Component Interconnect) bus or an EISA (Extended Industry Standard Architecture) bus, or the like. The bus 10002 may be divided into an address bus, a data bus, a control bus, and the like. For ease of representation, the bus 10002 is represented by one bold line in FIG. 10, but this does not indicate only one bus or one type of bus.

The memory 10003 may be a ROM (Read Only Memory) or other types of static storage devices that may store static information and instructions, a RAM (Random Access Memory) or other types of dynamic storage devices that may store information and instructions, may also be an EEPROM (Electrically Erasable Programmable Read Only Memory), a CD-ROM (Compact Disc Read Only Memory) or other optical disc storage, optical disk storage (including compact disks, laser disks, optical disks, digital versatile disks (DVDs), Blu-ray disks, etc.), a magnetic disk storage medium or other magnetic storage devices, or any other medium that can be used to carry or store desired program codes in the form of instructions or data structures and can be accessed by a computer, but are not limited to this.

The memory 10003 is configured to store an application code for executing the solution of the disclosure, and is controlled by the processor 10001 for execution. The processor 10001 is configured to execute the application codes stored in the memory 10003, to implement the contents shown in the foregoing method examples.

The electronic device includes, but is not limited to, mobile terminals such as a mobile phone, a notebook computer, a digital broadcast receiver, a PDA (Personal Digital Assistant), a PAD (Tablet Computer), a PMP (Portable Multimedia Player), and a vehicle-mounted terminal (e.g., a vehicle-mounted navigation terminal), and fixed terminals such as a digital TV and a desktop computer. The electronic device shown in FIG. 10 is merely one example and should not impose any limitations on the function and use range of the examples of the disclosure.

The server provided by the disclosure may be an independent physical server, and may also be a server cluster or a distributed system which is composed of a plurality of physical servers, and may also be a cloud server providing basic cloud computing services such as cloud services, cloud databases, cloud computing, cloud functions, cloud storage, web services, cloud communications, middleware services, domain name services, security services, CDNs, and big data and artificial intelligence platforms. The terminal may be a smartphone, a tablet computer, a notebook computer, a desktop computer, a smart soundbox, a smartwatch, or the like, but is not limited to this. The terminal and the server may be directly or indirectly connected through a wired or wireless communication mode, which is not limited to the disclosure here.

An example of the disclosure provides a non-transitory computer-readable storage medium, storing a computer program which, when running on a computer, enables the computer to execute the corresponding contents in the foregoing method examples.

It should be understood that although the steps in the flowcharts of the drawings are shown in sequence as indicated by the arrows, the steps are not necessarily performed in sequence in an order indicated by the arrows. The steps are performed without a strict sequence limitation and may be performed in other sequences unless explicitly stated here. Moreover, at least a part of steps in the flowcharts of the drawings may include a plurality of sub-steps or a plurality of stages, these sub-steps or stages are not necessarily executed to be completed at the same moment, but can be executed at different moments, and the execution sequence is not necessarily performed in sequence, but the sub-steps or stages can be performed in turn or alternately with other steps or at least a part of sub-steps or stages of other steps.

It should be noted that the above computer-readable medium of the disclosure can be a computer-readable signal medium or a computer-readable storage medium or any combination of the computer-readable signal medium and the computer-readable storage medium. The computer-readable storage medium may be, but is not limited to, for example, an electrical, magnetic, optical, electromagnetic, infrared, or semiconductor system, device or apparatus, or any combination of them. More specific examples of the computer-readable storage medium may include, but are not limited to: an electrical connector having one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any appropriate combination of them. In the disclosure, the computer-readable storage medium may be any tangible medium containing or storing a program that may be used by or in combination with an instruction execution system, apparatus or device. However, in the disclosure, the computer-readable signal medium may include a data signal propagated in a baseband or as part of a carrier wave, in which a computer-readable program code is carried. The propagated data signal may take a variety of forms, including, but not limited to, an electromagnetic signal, an optical signal, or any suitable combination of them. The computer-readable signal medium may also be any computer-readable medium other than the computer-readable storage medium, and the computer-readable signal medium can send, propagate, or transmit a program used by or in combination with an instruction execution system, apparatus or device. A program code contained on the computer-readable medium can be transmitted by using any appropriate medium including but not limited to: wires, optical cables, RF (Radio Frequency), etc., or any appropriate combination of them.

The above non-transitory computer-readable medium may be included in the above electronic device, or may also exist independently, but is not assembled in the electronic device.

The non-transitory computer-readable medium carries one or more programs that, when executed by the electronic device, cause the electronic device to perform the methods shown in the above examples.

According to one aspect of the disclosure, provided is a computer program product or a computer program, including computer instructions stored in a non-transitory computer-readable storage medium. A processor of a computer device reads the computer instructions from the computer-readable storage medium, and the processor executes the computer instructions, so that the computer device performs the methods provided in the various implementations described above.

Computer program codes for performing the operations of the disclosure may be written in one or more programming languages, or a combination of them, and the above programming languages include object-oriented programming languages, such as Java, Smalltalk and C++, and also include conventional procedural programming languages, such as a “C” language or similar programming languages. The program codes may be executed entirely on a user's computer, executed partly on a user's computer, executed as an independent software package, executed partly on a user's computer and partly on a remote computer or executed entirely on a remote computer or a server. In a scenario involving the remote computer, the remote computer may be connected to the user's computer through any type of network, including a local area network (LAN) or a wide area network (WAN), or may be connected to an external computer (for example, through the Internet using an Internet Service Provider).

Flowcharts and block diagrams in the drawings illustrate system architectures, functions, and operations, which may be probably implemented according to the systems, methods, and computer program products in various examples of the disclosure. In this regard, each block in the flowcharts or block diagrams may represent a module, program segment, or part of code, and the module, program segment, or part of code contains one or more executable instructions for implementing a specified logical function. It should also be noted that in some alternative implementations, the functions indicated in the blocks may also occur in a different order than those indicated in the drawings. For example, two blocks represented in succession may actually be executed substantially in parallel, and sometimes may also be executed in a reverse order, depending on the functions involved. It should also be noted that each block of the block diagrams and/or flowcharts, and a combination of blocks in the block diagrams and/or flowcharts can be implemented by special-purpose hardware-based systems that perform the specified functions or operations or a combination of special-purpose hardware and computer instructions.

Involved modules described in the examples of the disclosure may be implemented by software or hardware. In some cases, a name of a module does not constitute a limitation to the module itself, for example, a module A may also be described as a “module A for performing an operation B”.

The above descriptions are the preferred examples of the disclosure and the explanation of the applied technical principle. It should be understood by those skilled in the art that the scope of the disclosure involved in the disclosure is not limited to the technical solutions formed by a specific combination of the above technical features, and also should cover other technical solutions formed by any combination of the above technical features or equivalent features without departing from the concept of the disclosure. For example, the technical solution formed by replacing the above features with (but not limited to) technical features with similar functions disclosed in the disclosure.

1. A communication method, performed by an initiator, comprising:
determining a target wireless frame, wherein the target wireless frame comprises a first identification bit indicating that a type of the target wireless frame is a wireless local area network sensing Null Data Packet Announcement (WLAN Sensing NDPA) frame; and
sending the target wireless frame.

2. The communication method according to claim 1, wherein the target wireless frame comprises a Null Data Packet Announcement (NDPA) type field in which the first identification bit is carried.

3. The communication method according to claim 1, wherein the target wireless frame comprises a sounding dialog token number field; and
the sounding dialog token number field comprises a session identification of a sensing measurement session and an event identification of a measurement event comprised in the sensing measurement session.

4. The communication method according to claim 1, wherein the target wireless frame comprises a station information (STA info) field; and
the STA info field comprises an association identifier (AID) identification bit or a user identifier (UID) identification bit, the AID identification bit or the UID identification bit indicating a responder of sensing sounding.

5. The communication method according to claim 4, wherein the STA info field further comprises a sequence authentication code (SAC) identification bit indicating that the target wireless frame uses an encrypted long training field (LTF).

6. The communication method according to claim 4, wherein a receiver address (RA) of the target wireless frame comprises a medium access control (MAC) address of the initiator.

7. The communication method according to claim 1, wherein the target wireless frame comprises at least one STA info field; and
the STA info field comprises an association identifier (AID) identification bit assigned by the initiator to a responder during association.

8. The communication method according to claim 7, wherein the target wireless frame further comprises at least one of; an R21 NSS field, an NSS repetition field, and an I2R NSS field.

9. The communication method according to claim 7, wherein
a receiver address (RA) of the target wireless frame comprises a broadcast address or a unicast address; and
the unicast address comprises a media access control (MAC) address of each of the responders.

10. The communication method according to claim 1, further comprising:
receiving a null data packet (NDP) sent by a responder; or
sending a trigger frame to the responder, and receiving a null data packet (NDP) sent by the responder.

11. A communication method, performed by a responder, comprising:
receiving a target wireless frame, and acquiring a first identification bit carried in the target wireless frame, the first identification bit indicating that a type of the target wireless frame is a wireless local area network sensing Null Data Packet Announcement (WLAN Sensing NDPA) frame; and
performing a processing operation based on the first identification bit.

12. The communication method according to claim 11, wherein performing the processing operation based on the first identification bit comprises:
receiving a trigger frame sent by an initiator, and sending a null data packet (NDP) to the initiator; or
sending a null data packet (NDP) to the initiator.

13-14. (canceled)

15. An electronic device, comprising a memory, one or more a processors and a computer program stored on the memory and executable on the one or more processors, wherein the one or more processors are collectively configured to executes the computer programs, so as to perform:
determining a target wireless frame, wherein the target wireless frame comprises a first identification bit indicating that a type of the target wireless frame is a wireless local area network sensing Null Data Packet Announcement (WLAN Sensing NDPA) frame; and
sending the target wireless frame.

16. A non-transitory computer-readable storage medium, storing a computer program which, in response to determining that executed by one or more a processors, implements the communication method according to claim 1.

17. The electronic device according to claim 15, wherein the target wireless frame comprises a Null Data Packet Announcement (NDPA) type field in which the first identification bit is carried.

18. The electronic device according to claim 15, wherein the target wireless frame comprises a sounding dialog token number field; and
the sounding dialog token number field comprises a session identification of a sensing measurement session and an event identification of a measurement event comprised in the sensing measurement session.

19. The electronic device according to claim 15, wherein the target wireless frame comprises a station information (STA info) field; and
the STA info field comprises an association identifier (AID) identification bit or a user identifier (UID) identification bit, the AID identification bit or the UID identification bit indicating a responder of sensing sounding.

20. The electronic device according to claim 19, wherein the STA info field further comprises a sequence authentication code (SAC) identification bit indicating that the target wireless frame uses an encrypted long training field (LTF).

21. An electronic device, comprising a memory, one or more processors and a computer program stored on the memory and executable on the one or more processors, wherein the one or more processors are collectively configured to execute the computer program to perform a communication method according to claim 12.

22. A non-transitory computer-readable storage medium, storing a computer program which, in response to determining that executed by one or more processors, performs a communication method according to claim 12.
